(19) United States
(12) Patent Application Publication
(10) Pub. No.: US 2005/0049891 A1
(43) Pub. Date: Mar. 3, 2005

(54) System and method for assessing a supplier's compliance with a customer's contract terms, conditions, and applicable regulations

(75) Inventor: James R. Wilson, Provo, UT (US)

Correspondence Address: Steve M. Perry;THORPE NORTH & WESTERN, LLP, P.O. Box 1219, Sandy, UT, 84091-1219, US

(73) Assignee: Browz Group, LC.

(21) Appl. No.: 10/786,942

(22) Filed: Feb. 24, 2004

Related U.S. Application Data
(60) Provisional application No. 60/498,924, filed on Aug. 29, 2003.

(51) Int. Cl. G06F 17/60

(52) U.S. Cl. 705/1; 705/8

(57) ABSTRACT

The system and method are provided for assessing a supplier's compliance with a customer's contract terms, conditions, and applicable regulations. The method includes the operation of identifying a complete set of compliance provisions from contract terms, conditions, and applicable regulations for a customer's contract. Supplier compliance information can be gathered to quantify compliance by the supplier with the compliance provisions. The supplier compliance information can be stored in a database that is accessible over a network. A further operation is verifying the supplier compliance information using a verification provider in order to produce qualitative verification of supplier compliance information. Another operation is facilitating customer access over the network to the supplier compliance information for the compliance provisions.

This application claims priority to U.S. Provisional Application No. 60/498,924 filed Aug. 29, 2003.

### FIELD OF THE INVENTION

The present invention relates generally to assessing supplier's compliance with a customer's contract.

### BACKGROUND

In today's business marketplace, each ongoing business concern desires to manage the risks and possible losses associated with its business, regardless of the business size. Certainly there are risks associated with operating a smaller business but the risks tend to multiply as the size of a business increases. Not only do the risks increase as the relative size of the business increases but the possibility of loss is also multiplied because of the widespread operations of larger businesses. In fact, some business consultants believe that reducing or avoiding losses can be just as important as working on generating profits.

In addition to managing simple risk and loss, there are many other complex issues in today's business world that complicate the management of risk factors. Of course, there is the possibility of the simple loss of profits or merchandise damage, but there are also government rules and regulations that can apply to businesses. For example, some businesses are at risk that governmental regulators could shut down the business or that large fines could be accrued for misdeeds. In addition to governmental regulation, there is also the risk of loss through litigation or other similar legal means. Other risks that contribute to the overall risk analysis for a business are safety concerns, environmental quality, product quality, product liability, insurance, bonding, employee misdeeds, security clearances, disadvantaged business compliance, and similar risks that can be considered by the operating executives or owners of businesses. Furthermore, there are other extraneous risks that need to be assessed and managed such as acts of nature, explosions, fire, and computer failure.

In the past, businesses and corporations have been able to manage this risk by applying specific policies or training rules to their employees to minimize business risks. These policies and rules have included specific types of training, certifications, management and/or monitoring to avoid identified risks. In addition, companies have been able to purchase insurance to cover their own internal risks.

During recent years, many companies have outsourced various functions to third party suppliers or independent contractors. This shift has occurred in part because of the focus of many companies on their core competencies, as opposed to the vertical integration favored in the past. Unfortunately, it is difficult for a company to directly control the behavior of a supplier or independent contractor. For example, a relationship with a supplier or independent contractor can include an inherent level of risk in the following areas: regulatory compliance, insurance expiration, supply interruptions, citation histories, bonding, financial stability, environmental performance, safety reporting, quality performance, employee testing, security, and licensing. Notwithstanding the difficulty in managing the risk created by using outside suppliers, companies desire to manage the risk because this risk flows back to the customer or company.

A larger company may hire a smaller contractor to do a specific job that has inherent risks. Previously, the company may have had this service provided by its own employees and the employees would have been reasonably trained, tested, and appropriately bonded or insured. However, a small supplier or independent contractor who is providing products or services to the larger company may not take these types of precautions. Then when an accident occurs, the larger company or customer may be liable in litigation for problems or accidents resulting from the services or products.

For instance, a petroleum company may hire a welding supplier to work on the petroleum company's oil pipeline system. This welding supplier may be a small welding company that is locally owned or operated. If this welding company hires a welder who is untrained, uninsured, or has a substance abuse problem, then an accident may occur. The welding accident on the oil pipeline might produce an explosion that kills innocent bystanders. Thus, the petroleum company will almost certainly be named in, and may ultimately be held responsible for the resulting litigation that comes from the entire matter, even though the services were provided by an independent supplier.

Because of the risks described above, customers or companies who receive services from suppliers and independent contractors are interested in managing their risk from those suppliers in the most effective, efficient, and thorough manner possible. A smaller company, for example, may be able to closely examine and interface with suppliers to determine the attendant risks for working with a given supplier. However, as a company becomes larger, it becomes significantly more difficult to determine the risk associated with each supplier that supplies services and products to a company. A large Fortune 500 company may have up to 40,000 or more separate service providers. In addition, these service providers can cover a wide range of industries, products, and disparate services.

When a relationship is formed between a customer company and a supplier, at least one contract is typically signed between them. Larger companies typically require the contract with the supplier to include certain terms, conditions, and compliance with government regulations. The terms, conditions, and applicable regulatory provisions that are included in these contracts are quite detailed and can run into the range of hundreds of pages of contract requirements. Once the supplier has agreed to a set of extensive terms, conditions, and applicable government regulations, the customer company is left in the position of determining whether there is actual compliance with all the provisions.

The typical way in which companies have attempted to determine whether a supplier is in compliance with the terms, conditions, and applicable regulations of the contract is to perform further due diligence and research about compliance. For example, a long form or document with questions may be sent to the supplier and the supplier can be asked to disclose an extensive list of information to the customer. It is not atypical for such a compliance due diligence questionnaire or form to range anywhere from 1 to 100 pages or more. The types of questions the supplier is asked to answer can cover a wide range of areas from the executed contract. These issues can include safety, environmental, product liability, insurance, bonding, and other similar issues.

The supplier sends this extensive survey or form to their own compliance department, which fills out the form in detail and supplies the requested compliance information to the customer. If the supplier does not have a compliance or due diligence staff, then the supplier may employ the valuable time of their management staff, servicing staff or others to reply to these information requests. The research and employee time involved in filling out due diligence surveys for such terms, conditions, and applicable regulations can involve tens or even hundreds of man hours. As can be imagined, this amount of compliance work can incur a significant cost for the supplier.

When the customer receives this due diligence information covering compliance with the contract's terms, conditions, and applicable regulations, then the customer must also spend tens or hundreds of hours in organizing and analyzing this information on the paper form to determine if the information received is appropriate, complete, and accurate. This exercise in due diligence helps the customer to better manage the risk associated with having many suppliers. Otherwise, the contract terms and conditions are merely agreed upon but are not necessarily implemented or supported.

Regrettably, there are a number of disadvantages with the current system. Many companies have found that when there is a problem with a supplier, then the compliance documents for the terms and conditions of the contract are pulled out of a physical archive system and reviewed. What may be found is that much of the original survey information is incomplete, missing, old, or incorrect. Principally, it is difficult to monitor continued compliance during the term of the contract.

In addition, the customer must pay for the storage of all this hard copy information at their site or at some remote storage location. A customer who has 30,000 or 40,000 suppliers is likely to have a very extensive collection of such contracts, due diligence surveys and related documents. In addition, a customer may have entire departments of individuals who are responsible for the upkeep, analysis, and completion of the risk management information.

The entire process of determining whether or not a supplier conforms to the appropriate terms, conditions, and applicable regulations of a customer's contract is an extremely expensive and time consuming process for a customer company. Furthermore, this entire process does not generally contribute to the customer's bottom line. In particular, the resources that are directed towards this process simply incur additional overhead for a customer company.

Regardless of how much time and energy is spent on these due diligence processes, there may be overlooked items or incomplete information which will be later brought forth in litigation, government compliance inspections, or governmental hearings that are to the detriment of the company. Despite the reduced risk provided by addressing compliance, the risk is not reduced as much as the customer's executive officers and directors would like because of the gaps and inconsistencies in the compliance process. Indeed, when many company executives have been asked what one of their most serious problems is, they reply that it is managing general risk and supplier risk.

### SUMMARY OF THE INVENTION

The invention provides a system and method for assessing a supplier's compliance with a customer's contract terms, conditions, and applicable regulations. The method includes the operation of identifying a complete set of compliance provisions from contract terms, conditions, and applicable regulations for a customer's contract. Supplier compliance information is then gathered to quantify compliance by the supplier with the compliance provisions. The supplier compliance information can be stored in a database that is accessible over a network. A further operation is verifying the supplier compliance information using a verification provider in order to produce qualitative and quantitative verification of supplier compliance information. Another operation is facilitating customer access over the network to the supplier compliance information for the compliance provisions.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart illustrating a method for assessing a supplier's compliance with a customer's contract in accordance with an embodiment of the present invention;

FIG. 2 is a block diagram depicting an embodiment of a system for assessing a supplier's compliance with a customer's contract;

FIG. 3 is a flow chart illustrating an embodiment of a method for assessing a supplier's compliance with a customer's contract and charging suppliers a periodic fee for verification in accordance with an embodiment of the present invention;

FIG. 4 is a block diagram illustrating an embodiment of a system of marketing a verification system for supplier compliance with a customer's contract in accordance with an embodiment of the present invention;

FIG. 5 is a block diagram illustrating the centralization of supplier compliance information in accordance with an embodiment of the present invention; and

FIG. 6 is a block diagram illustrating the redundant and decentralized nature for prior art methods of communicating compliance information.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention includes a system and method for assessing a supplier's compliance with a customer's contract terms, conditions, and applicable regulations. One method for assessing a supplier's compliance will first be described followed by a more detailed description of an embodiment of the system.

The method includes the operation of identifying a complete set of compliance provisions from contract terms, conditions, and applicable regulations for a customer's contract as in block 100. Each customer typically has a customizable boilerplate contract that is signed by each supplier doing business with the customer. For example, a large company, such as IBM, will have business relationships with many contractors and suppliers. These relationships contain an inherent level of risk. In order to mitigate that risk, IBM executes a contract with a supplier that includes certain terms, conditions, and applicable regulations. These terms, conditions, and applicable regulations can include provisions regarding: government regulatory compliance, insurance verification, supply interruptions, regulatory citation histories, bonding, financial stability, environmental performance, safety reporting, quality performance, employee testing, security, and licensing. Out of this listing a complete set of terms, conditions, and applicable regulations can be selected. This complete set is defined as a set of terms that the customer or another third-party is interested in verifying the accuracy, correctness, completeness, and validity of the information. Thus, a complete set does not necessarily include every term, condition and applicable regulation for a contract, but just those compliance provisions identified by the customer as provisions the customer desires to have checked and validated.

An additional operation is gathering supplier compliance information quantifying compliance by the supplier with the compliance provisions as in block 102. The quantitative information that can be collected is generally defined as unverified data collected from the suppliers. For example, quantitative data can include information such as whether the supplier is current on their insurance premiums or the supplier's reported financial strength. There are a number of ways that the supplier can provide this compliance information. For example, the supplier can enter the compliance information electronically over a network or the Internet. Alternatively, certain items can be scanned and stored in a database (e.g. insurance certificates), or the compliance information may be given over the phone to an agent who types the compliance information into an electronic database. Other data gathering methods will also be known to those skilled in the art.

A further operation of the present method is storing the collected supplier compliance information in a database that is accessible over a network as in block 104. The database can be accessible over any type of network that connects a plurality of computers together. For example, the network can be a local area network (LAN), a wide area network (WAN), the Internet, wireless network, or some other electronic network that is used by the customer or supplier.

Once the compliance information has been stored in a database, a verification provider can then verify the supplier compliance information in order to produce qualitative verification of the supplier compliance information as in block 106. The qualitative verification of the compliance information can include having an agent of the verification provider verify the compliance information furnished by the supplier for accuracy, level of compliance, completeness, and general correctness. Specifically, the verification provider can check pre-determined parts of the compliance information. In addition, the verification provider can have automated processes that perform an electronic query against third-party databases to determine whether or not the supplier is in compliance with specified compliance provisions. One example of the automated verification is that the supplier may provide information stating that the supplier has not had any safety incidents. A safety incident may be an OSHA violation. Accordingly, software for the verification provider (or the agent for the verification provider) can go online and check the OSHA database to determine that the number of incidents is in fact zero, as represented by the supplier. Similar checks can be performed for insurance, financial status, and other provisions.

Using a verification provider to verify the supplier compliance information is valuable from at least two perspectives. For instance, the verification provider can check compliance data where relatively large risks are known to exist and this increases the customer's confidence in the supplier's compliance information. Suppliers are also more likely to provide complete and accurate information to the customer and verification provider because they realize some or all of the information supplied may be checked by a third party verification provider.

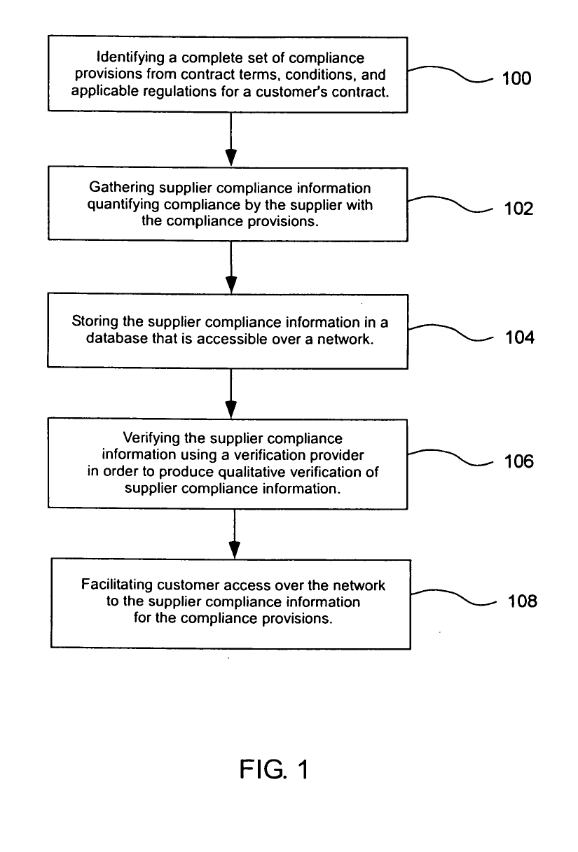

Referring again to FIG. 1, a further operation is facilitating customer access over the network to the supplier compliance information for the compliance provisions as in block 108. In one embodiment of the invention, the customer can access the data stored in a database over the network using a network browser. Network browsers have become a convenient method for securely accessing remote data over the Internet or other private networks. Alternative ways can also be provided for the customer to access data over the network. For example, a compiled application, interpreted application (e.g. Java), or another electronic client can be used to access the verified data in the database.

The verification of the supplier compliance information can further comprise the operation of generally assessing the correctness of portions of this prior compliance information. In order to select the portions that will be verified, the verification provider can identify these areas with the customer in a face-to-face meeting. This selection of information to be verified can be done electronically where the customer enters areas to be verified through a graphical user interface. As mentioned before, the actual verification can be done using automated querying of third party databases. Alternatively, the verification may be done by an agent on the telephone who calls government agencies or repositories of information in order to confirm the desired information. Although the use of electronic searching and electronic messaging is a valuable way to reduce the cost of verifying the compliance information, there are likely to be human researchers involved to verify the supplier compliance information.

Even after the complete set of contract terms, conditions, and applicable regulations has been identified, this set can be expanded as the customer's contract elements change. This means that the verification provider or customer may continue to identify important terms, conditions, and applicable regulations and then add the emerging business regulations or issues as the business regulations become effective and the issues are needed.

In addition to simply facilitating customer access to the supplier compliance information, a software program in communication with the supplier information database can provide reporting capabilities for the complete set of contract terms, conditions, and applicable regulations. These reporting capabilities can be tabular reports, grids, spreadsheets, detail screens, emails, printed reports mailed to the customer, or any type of reporting that the customer desires.

In one embodiment of the invention, the tabular or line item report format can provide a management by exception feature or an active reporting feature that is useful for customers. A graphical interface control or icon can be supplied with each supplier or line item as defined by the customer or the validation provider. For example, this graphic interface control may be a graphic that is red or yellow in color to indicate noncompliance or green in color to indicate compliance. Alternatively, “yes” or “no” text can be provided to show whether a customer is in compliance or not. In an additional embodiment, the noncompliant provisions can be shown together and the compliant provisions can be shown in another window or section of the program. This allows a customer to quickly identify areas where a supplier is not compliant. Other management by exception features and interfaces can be devised by those skilled in the art.

The system and method for accessing supplier compliance by exception also includes the ability to allow customers to manage their suppliers by viewing specific exceptions regarding the supplier. For example, if a listing is provided of a customer's suppliers, each supplier can have a graphical icon or other text indication as to whether they are in compliance. Then a supplier detail screen can be provided which displays icons or messages for specific supplier validation areas that are out of compliance. Such indicators can notify a customer that further steps should probably be taken or that the customer can check with the supplier to see if the supplier can come into compliance.

In one embodiment of the invention, the highest priority item that is out of compliance can be displayed to a customer at the top of the list. In addition, a mouse-over popup balloon can be provided that indicates the next action to be taken for an out-of-compliance provider. Popup balloons can also be used to show which item is out of compliance in a given area or for a given supplier. Suppliers that are currently in compliance can also have that information displayed in a balloon or adjacent their name. Particularly, the next event that will take a supplier out of compliance is valuable and can be displayed to the customer in a balloon or near the supplier's name. This enables a pro-active compliance approach to be taken.

A summary report about compliance or noncompliance can be provided to the customer or a more detailed compliance report can be provided. For example, each customer can receive a detailed record of a supplier's compliance information that outlines all the areas of verified data and other customer data collected. An example of detailed supplier information can be a report that includes a supplier's financial strength information as rated by Dunn and Bradstreet. This information is only part of the detailed portfolio that can be included. Another example is detailed insurance data that can be provided on a “drill-down” data screen. This detailed insurance data can illustrate current insurance compliance which corresponds with the insurance agreed to in the contract. With respect to insurance, a user may also be asked to provide verification of a current insurance document. Such documents may be scanned into the database by the supplier and viewed by the customer.

Not only can the verification information be provided to a customer for a one-time verification but regularly updated supplier compliance information can be provided to the supplier and customer on an ongoing basis. In one embodiment of the invention, this means that the supplier compliance information is continuously updated. Alternatively, all or part of the supplier compliance information can be updated quarterly or semi-annually. In addition to the constant update of the information, the verification provider can provide a notification of any changes in supplier status to the customer. This notification can be provided via email, regular mail, telephone, or through another communication method. This notification can be automated through the verification provider's database or it can be provided by a human individual who contacts the customer.

The information collected by the verification provider can be updated periodically as agreed to between the verification provider and the customer or updated constantly as new information is received by the verification provider, customer or supplier. Constant updates can be provided if included in the setup agreement between the verification provider and the customer. These multiple levels of verification may use different levels of fee structures.

Maintaining current data allows the verification provider to notify a supplier of important compliance due dates that are about to expire and the relevant expiration date. One example of this is to email the customer when a supplier's insurance is about to expire. In addition, the supplier can also be notified that there are important expiring dates and the customer is aware of these dates.

With respect to automatic notification prior to important changes in status, there are many areas where the verification provider can notify the customer. The areas where automatic notification is particularly beneficial include, but are not limited to the areas of insurance, permits, training, leases, licensing, certifications, documents, contracts, and other similar date driven compliance information.

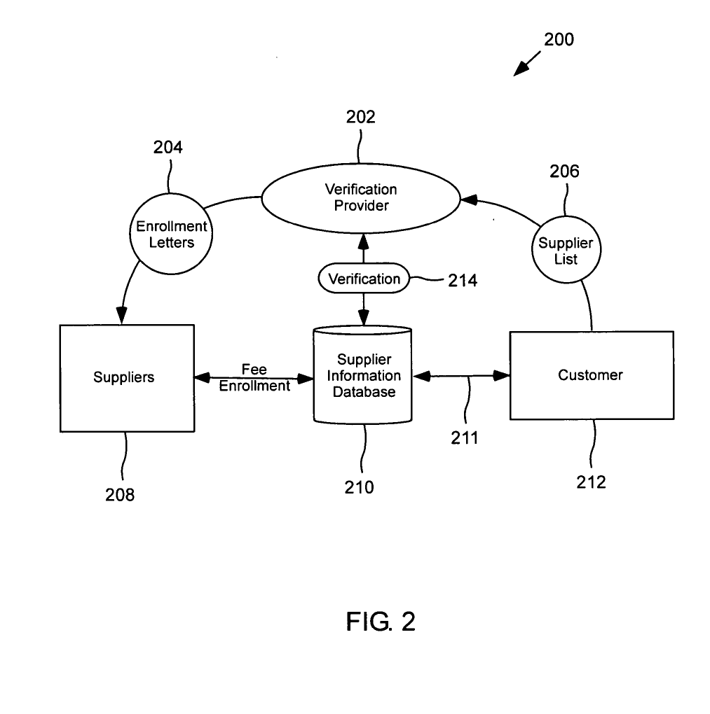

FIG. 2 illustrates a system for assessing a supplier's compliance with the customer's contracts. Particularly, a system includes a customer 212 who has a contract containing a plurality of compliance provisions that are identified or selected from a larger number of contract terms, conditions, and applicable regulations. One or more suppliers 208 are involved in the system because the suppliers have agreed to a contract with the customer. When the supplier provides services, products, or other contracted items to a customer, the supplier generally enters into a contract that includes terms, conditions, and applicable regulations. As discussed previously, it is difficult for the customer to verify that these terms, conditions, and applicable regulations are being adhered to. In addition, it is also difficult for the customer to check that these compliance provisions are being regularly maintained.

To insure that this verification takes place, a verification provider 202 is included in the present system. The verification provider is empowered by the customer to gather a quantity of supplier compliance information related to the supplier compliance provisions. Once this information has been gathered, the verification provider can then verify 214 the supplier compliance information. This verification by the verification provider in turn produces qualitative verification of the supplier compliance information.

In order to obtain the supplier compliance information, the verification provider can acquire a supplier list 206 from the customer or from a source that has the customer's supplier list. Then the verification provider can initiate the transmission of enrollment letters 204 to the supplier. These enrollment letters may be paper letters on the customer's letterhead that are sent from the verification provider or from the customer. Alternatively, the verification provider or customer can send emails, instant messages, other electronic, or any reasonable communication to inform the supplier to sign-up for the verification service.

The present system and method for creating and accessing validated supplier compliance information is valuable to customers or corporations because the present invention outsources the collection and management of supplier and contractor compliance information. In addition, this invention provides a third party or an outsourcing group that can verify insurance requirements, licenses, financial ratings, safety performance, and other criteria that are specified by the customer or identified by the verification provider. This third-party check helps ensure that the supplier compliance information will not be biased or reviewed in a haphazard manner. Providing an electronic system such as the one described also simplifies the collection of information from the customer's side and from the supplier's side.

Independent verification is a valuable benefit of the present invention. The contractor and supplier information is verified for accuracy against public and private databases where possible. Then the verified information is posted to the password protected database or website. Typical sources of electronic verification include the Bureau of Labor, OSHA, Worker's Compensation Fund, Dunn and Bradstreet, Lexis/Nexis, Federal Bankruptcy Courts, State District Courts, State Tax Commissions, Insurance Carriers, the State Department of Business, the State Department of Industry, and other electronic databases that can be queried for verification.

A supplier information database 210 in FIG. 2 is configured for storing the supplier compliance information that has been received. Verification data can also be stored in the supplier information database as needed or in a separate database. Customers and suppliers may access the supplier information database 210 through the computer network 211 or the Internet.

Since this verified information can be provided over a computer network or the Internet, the electronic delivery of the verified information minimizes the customer's operational risk and reduces a customer's costs, while improving its business performance and profit. Some of the cost is minimized because the customer does not store volumes or warehouses of information about their suppliers and the information is stored electronically in a database.

Suppliers and contractors also benefit from this system and method of accessing supplier compliance data because it provides an improved way to report their compliance information to their customers. Typically suppliers have had to fill out a separate compliance form or go through a separate due diligence with each customer, and this increases the supplier's cost of doing business with each customer. The present system and method allow suppliers to warehouse this redundant information with the verification provider and provide the redundant information to more than one customer.

The customers may also receive a more timely compliance response from the suppliers and contractors because their information is entered into a database electronically. Electronic entry is faster and the centralization of information allows the supplier to enter their compliance data for a given topic just once. Not only are the current digital documents managed electronically, which reduces space, saves storage costs, and reduces the customers overhead, but the older supplier compliance information is digitally archived for access as needed.

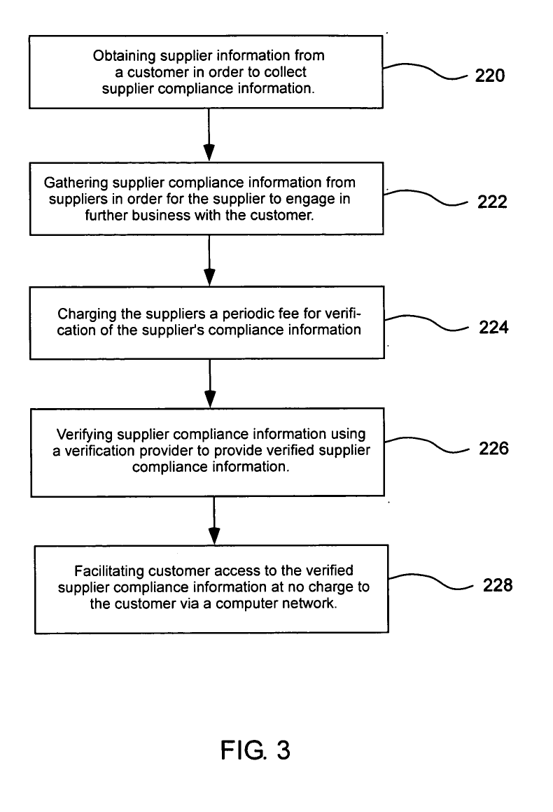

FIG. 2 further illustrates that the supplier can pay a fee for enrollment into the verification system and process. A method for enrolling suppliers with a fee but supplying the verification service to a customer at no charge is further illustrated in the flow chart of FIG. 3.

FIG. 3 illustrates a method for assessing the supplier's compliance with the customer's contract terms, conditions, and applicable regulations. The method includes the operation of obtaining supplier information from a customer in order to collect supplier compliance information as in block 220. The supplier compliance information can include any relevant information about the supplier company and the customer's contract terms, conditions and applicable regulations for the supplier. Supplier compliance information can be gathered from suppliers who provide the supplier compliance information in order for the supplier to engage in further business with the customer as in block 222.

A periodic fee may be charged to the suppliers for verification of the supplier's compliance information as in block 224. The periodic fee can be a yearly fee, monthly fee, weekly fee, or a fee for verifying specific blocks of data.

A further operation is verifying the supplier compliance information using a verification provider to provide verified supplier compliance information as in block 226. Once this verified information has been created, the customer access to the verified information can be facilitated using a computer network as in block 228. In one embodiment of the invention, this access by the customer to the information can be supplied at no charge to the customer. For example, a no charge situation may apply to customers who have an extremely large number of suppliers and contractors, or to a customer who is initially joining the system. Alternatively, a charge may be assessed as deemed appropriate by the verification provider. A periodic or annual fee may also be charged by the verification provider to the customer as set by the verification provider.

In this method, the step of gathering the supplier compliance information can further include a direct request to the suppliers to electronically enter their compliance information into the supplier verification database. Alternatively, the verification provider may request other data entry methods such as sending paper copies of certifications to a validation agent. The initial request for information can be made using the customer's official letterhead using the signature of a customer's executive officer. Optionally, the request to the supplier can be made by an email from the customer.

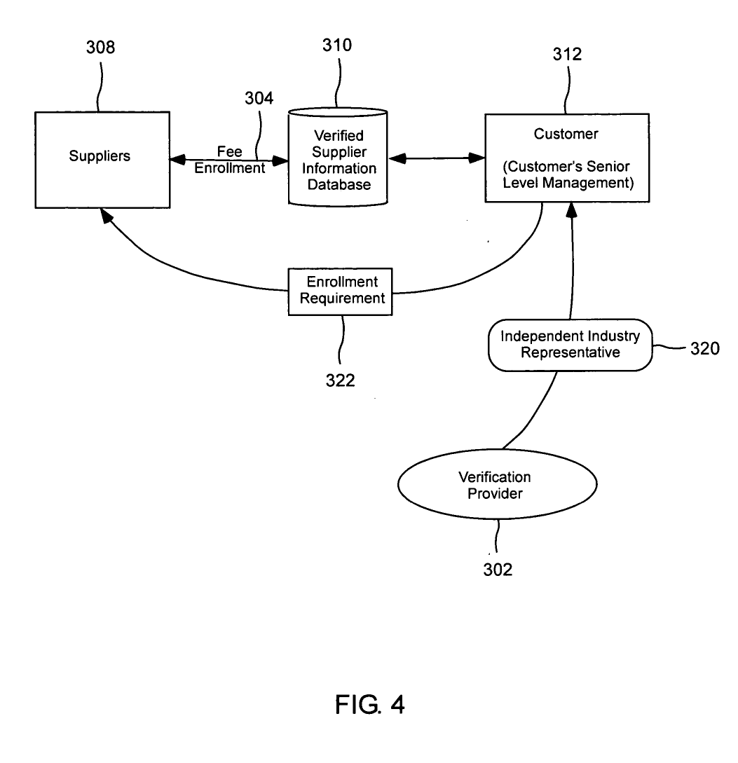

FIG. 4 is a block diagram to help illustrate a system and method of marketing a verification system for supplier compliance with a customer's contract terms, conditions, and applicable regulations. The method includes the step of involving an independent industry representative 320 who is able to arrange a communication with the customer's senior level management. The independent industry representative is generally recruited by the verification provider 302 in order to make a contact with the customer for the verification provider.

Another step is presenting the verification system for supplier compliance to the customer's senior level management 312 based on the independent industry representative's 320 involvement or contact. The acceptance of the verification system by the customer allows the verification provider 302 or customer to initiate the step of collecting supplier compliance information from suppliers regarding compliance with contract terms, conditions, and applicable regulations.

The collection of the supplier compliance information may be generated by an enrollment requirement 322 from the customer 312 to supplier 308. Accordingly, the supplier compliance information can be entered into a verified supplier information database 310. The suppliers may enroll in the verification system in order for the supplier to engage in further business with the customer.

The suppliers 308 can be charged a periodic fee 304 for enrollment in the verification system. This periodic fee can be a monthly fee, a quarterly fee, or a yearly fee for enrollment in the verification system. The customers 312 can also be charged a periodic fee for their access to the verified supplier information database. Alternatively, the customer may be provided access to the verified supplier information database 310 with no fee during an initiation period or as determined by the verification provider 302.

The independent industry representative can have incentives to be involved in inviting a customer to sign up for the verification system with the verification provider. One incentive can be a contract between the independent industry representative and the verification provider to pay the independent industry representative a fee for arranging a meeting with the customer's senior level management. This fee can be a commission on the periodic fees collected from the suppliers and/or customer, a flat fee arrangement, or some other fee structure that can be devised by those skilled in the art.

The independent industry representative can be a former senior executive with senior executive management contacts. For example, the independent industry representative may have been a former senior executive at the customer company that the verification provider desires to have contact with or the independent industry representative may have been a former senior executive at a different company who has contacts with the customer company. The independent industry representative can even be a current senior executive within the customer company. In addition to the independent industry representative being a former executive, any other individual with contacts to a senior executive of a potential customer can be used. Examples of this include a relative of senior management of the potential customer, a lawyer, an accountant, an independent sales representative, a politician, or any other individual who has access to the senior management of the potential customer. The reason access to senior management is desired is because middle levels of management may not desire to adopt the present system and method because it may effect their employment or the employment of those in their division.

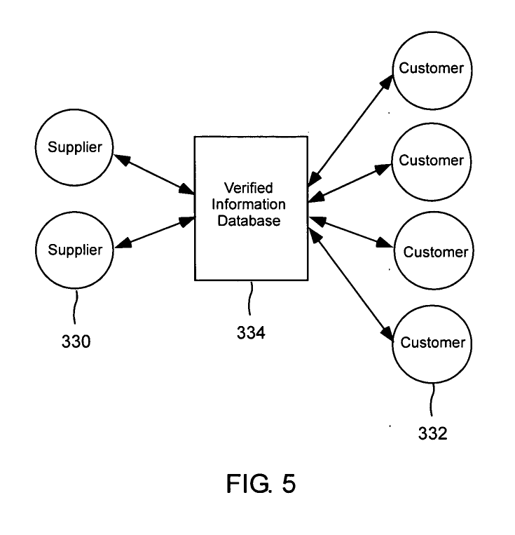

As illustrated in FIG. 5, the system for accessing supplier compliance with the customer's contract terms, conditions, and applicable regulations provides the benefit that each supplier reports their compliance information a single time to a single centralized repository. FIG. 5 illustrates that a supplier 330 can enter its compliance information with regard to any known safety, insurance, security, government regulation, or any other related compliance information. The compliance information can be included in a verified information database 334 that can be supplied to multiple customers 332. The present system enables a customer to be able to access a single data interface with a single verification provider to obtain information about all of its suppliers or vendors without sending redundant requests for information to each of these customers. This centralization is available whether the customer has 10 suppliers or 30,000 suppliers.

Not only do customers benefit from the present invention, but suppliers and contractors can benefit from additional opportunities and exposure to potential customers. This is because suppliers can contract with the verification provider to allow their supplier information to be provided to any or all of the customers located in the verification provider's database. For example, if a customer is looking for a specific service provider, they can search in a directory of suppliers kept by the verification provider in order to determine which suppliers comply with their verification requirements and may be potential suppliers. This feature can also be used to pre-qualify potential suppliers for a customer. If a customer decides that they desire to do business with a supplier, they can have the suppliers pre-qualified through the verification provider before any actual contract is signed. This is an improvement over previous methods where the contract was signed first and then the contractor was later qualified.

The implementation of digital compliance management and electronic archiving provides additional benefits for the end customers and suppliers. The electronic nature of a centralized repository provides easy access to the supplier and contractor information via a secure website or secure software application. If an open architecture is implemented, this provides flexible searching and reporting parameters for the customer. In addition, the electronic nature of the information enables management by exception because less important details can be hidden and high priority details can be flagged at a higher access level.

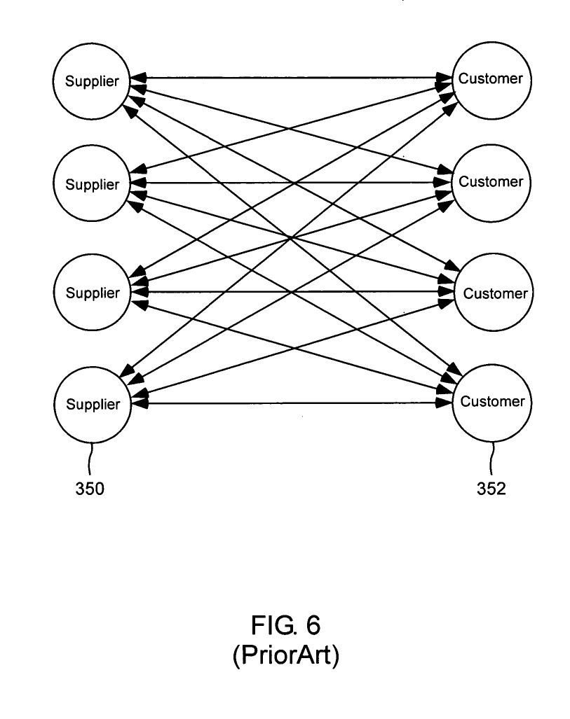

Another benefit of the centralized approach avoids the redundancies and confusion created by suppliers who currently have to repeatedly disclose similar information in different formats for multiple customers. The repetition of this information as created by past practices is illustrated in FIG. 6. The current industry's standard is illustrated where each supplier 350 reports to each customer 352. The supplier's compliance information is separately reported on paper to each different customer in a different format and to a different compliance officer. By comparison, the system and method of the present invention saves an enormous amount of time and money that is generally wasted for checking or gathering redundant information. Furthermore, effort is saved that has duplicated in the past between multiple contracts or contracting parties.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for assessing a supplier's compliance with a customer's contract terms, conditions, and applicable regulations, comprising the steps of:
identifying a complete set of compliance provisions from contract terms, conditions, and applicable regulations for a customer's contract;
gathering supplier compliance information quantifying compliance by the supplier with the compliance provisions;
storing the supplier compliance information in a database that is accessible over a network;
verifying the supplier compliance information using a verification provider in order to produce qualitative verification of supplier compliance information; and
facilitating customer access over the network to the supplier compliance information for the compliance provisions.

2. A method as in claim 1, wherein the step of verifying the supplier compliance information further comprises the step of assessing the correctness of portions of the supplier compliance information.

3. A method as in claim 1, wherein the step of verifying the supplier compliance information further comprises the step of comparing supplier compliance information with electronic databases containing information for confirming the supplier compliance information.

4. A method as in claim 1, wherein the step of verifying the supplier compliance information further comprises the step of comparing supplier compliance information with confirmation information obtained by human researchers to verify the supplier compliance information.

5. A method as in claim 1, wherein the step of identifying a complete set of contract terms further comprises the step of adding emerging business regulations as the business regulations become effective.

6. A method as in claim 1, wherein the step of facilitating customer access further comprises the step of providing reporting capabilities for the complete set of contract terms, conditions, and applicable regulations for the compliance provisions.

7. A method as in claim 1; further comprising the step of providing information regarding the supplier's compliance with a customer's contract terms, conditions and applicable regulations to both the supplier and the customer on an ongoing basis.

8. A method as in claim 1, further comprising the step of notifying a supplier of important compliance due dates that are about to expire and a relevant expiration date.

9. A method as in claim 1, further comprising the step of notifying a customer of important supplier due dates that are about to expire and a relevant expiration date.

10. A method as in claim 1, further comprising the step of organizing the supplier compliance information in a logical, consistent and easy to use format

11. A system for assessing a supplier's compliance with a customer's contract terms, conditions, and applicable regulations, comprising:
a customer having a contract with a plurality of compliance provisions identified from contract terms, conditions, and applicable regulations;
a supplier who has agreed to the contract with the customer;
a verification provider that is enabled to gather supplier compliance information related to the compliance provisions and enabled to verify the supplier compliance information in order to produce qualitative verification of the supplier compliance information;
a database configured for storing the supplier compliance information; and
a computer network configured for facilitating access by the customer over the network to the supplier compliance information for the compliance provisions.

12. A method for assessing supplier compliance with a customer's contract terms, conditions, and applicable regulations, comprising the steps of:
obtaining supplier information from a customer in order to collect supplier compliance information that includes the customer's contract terms, conditions, and applicable regulations for a supplier;
gathering supplier compliance information from suppliers who provide the supplier compliance information in order for the supplier to engage in further business with the customer;
charging the suppliers a periodic fee for verification of the supplier's compliance information;
verifying supplier compliance information using a verification provider to provide verified supplier compliance information; and
facilitating customer access to the verified supplier compliance information at no charge to the customer via a computer network.

13. A method as in claim 12, wherein the step of verifying the supplier compliance information further comprises the step of verifying supplier compliance information that includes a complete set of contract terms, conditions, and applicable regulations contained in a customer's contract with the supplier.

14. A method as in claim 12, further comprising the step of contacting the suppliers with a request to enter supplier compliance information into a verification database.

15. A method as in claim 14, wherein the step of contacting the suppliers further comprises the step of having the customer contact the suppliers with a request to enter supplier compliance information into the verification database.

16. A method as in claim 14, wherein the step of contacting the suppliers further comprises the step of contacting the suppliers using an official customer contact channel with a request to enter supplier compliance information into the verification database.

17. A method as in claim 14, wherein the step of contacting the suppliers further comprises the step of contacting the suppliers using a customer's official letterhead and signature of a customer's executive officer, with a request to enter the supplier compliance information into the verification database.

18. A method as in claim 12, further comprising the step of contracting with the suppliers to receive the supplier compliance information which includes the supplier compliance with a customer's contract terms, conditions, and applicable regulations.

19. A method as in claim 12, wherein the step of charging the supplier a periodic fee further comprises the step of charging the supplier a periodic fee selected from the fees consisting of: a yearly fee, a semiannual fee, a quarterly fee and a monthly fee.

20. A method as in claim 12, further comprising the step of displaying exceptions regarding the supplier's compliance information to a customer that are not in compliance, while hiding compliance information that is in compliance.

21. A method of marketing a verification system for supplier compliance with a customer's contract terms, conditions, and applicable regulations, comprising the steps of:
involving an independent industry representative who is able to arrange a communication with a customer's senior level management;
presenting the verification system for supplier compliance to the customer's senior level management based on the independent industry representative's involvement;
collecting supplier compliance information from suppliers regarding compliance with contract terms, conditions, and applicable regulations; and
enrolling the suppliers in the verification system in order for the supplier to engage in further business with the customer

22. A method as in claim 21, further comprising the step of charging the suppliers a periodic fee for enrollment in the verification system.

23. A method as in claim 21, further comprising the step of charging the suppliers of the customer a yearly fee for enrollment in the verification system.

24. A method as in claim 21, wherein the step of charging the suppliers a periodic fee further comprises the step of charging the suppliers a periodic fee for verification of the supplier compliance information.

25. A method as in claim 22, wherein the step of utilizing an independent industry representative further comprises the step of contracting with an independent industry representative to pay the independent industry representative a fee for arranging a meeting with a customer's senior level management.

26. A method as in claim 22, wherein the step of utilizing an independent industry representative further comprising the step of contracting with an independent industry representative to pay a commission on the periodic fees collected from the suppliers.

27. A method as in claim 21, further comprising the step of enabling customer electronic access to the supplier compliance information at no charge to the customer.

28. A method as in claim 21, wherein the step of utilizing an independent industry representative further comprises the step of contracting with an independent industry representative that is a former senior executive with senior executive management contacts.

29. A method as in claim 21, wherein the step of utilizing an independent industry representative further comprises the step of contracting with an independent industry representative that is a current senior executive with senior executive management contacts.

30. A method as in claim 21, wherein the step of enrolling the suppliers further comprises the steps of:
contacting the suppliers with a request to enter supplier compliance information into an electronic verification database in order to remain on a supplier's customer list;
contracting with the suppliers to receive the supplier compliance information which includes the supplier's compliance with contract terms, conditions, and applicable regulations of a customer;
verifying the supplier compliance information;
charging the suppliers a periodic fee for the verification and storage of the verified supplier compliance information;
enabling the customer to access verified supplier compliance information stored in the electronic verification system at no charge to the customer.

31. A method as in claim 21, further comprising the step of receiving a supplier list from the customer.

32. A method as in claim 31, further comprising the step of using the customer's official correspondence channel in order to contact the suppliers on the supplier list.

33. A method as in claim 31, further comprising the step of contacting pre-determined portions of the suppliers on the supply list during one year until all the suppliers are contacted.

34. A method as in claim 21, further comprising the step of agreeing with a customer to require suppliers to sign up for the supplier compliance program in order to maintain a supplier relationship with the customer.

35. A method as in claim 21, further comprising the step of enrolling suppliers who the customer designates as minor suppliers at no charge to the supplier.

36. A method as in claim 34, further comprising the step of scanning in the minor supplier information without verification.

37. A method as in claim 34, further comprising the step of displaying exceptions in the supplier's compliance information that are not in compliance, while hiding compliance information that is in compliance.

38. A method for assessing a supplier's compliance with a customer's contract terms, conditions, and applicable regulations, comprising the steps of:
identifying a plurality of compliance provisions from contract terms, conditions, and applicable regulations for a customer's contract;
gathering supplier compliance information quantifying compliance by the supplier with the compliance provisions;
storing the supplier compliance information in a database that is accessible over a network;
verifying the supplier compliance information using a verification provider in order to produce qualitative verification of supplier compliance information; and
facilitating customer access over the network to the supplier compliance information for the compliance provisions.

39. A method for assessing supplier compliance with a customer's contract terms, conditions, and applicable regulations, comprising the steps of:
obtaining supplier compliance information specified by a customer that includes the customer's contract terms, conditions, and applicable regulations for a supplier;
gathering supplier compliance information from suppliers who provide the supplier compliance information to be further qualified to be engaged in business with the customer;
charging the suppliers a periodic fee for verification of the supplier's compliance information;
verifying supplier compliance information using a verification provider to provide verified supplier compliance information; and
facilitating customer access to the verified supplier compliance information at no charge to the customer via a computer network.

40. A method as in claim 39, wherein the step of verifying the supplier compliance information further comprises the step of verifying supplier compliance information that includes contract terms, conditions, and applicable regulations contained in a customer's contract with the supplier as specified by a customer.

41. A method as in claim 39, wherein the step of charging the suppliers a periodic fee further comprises the step of charging the suppliers a yearly fee for ongoing verification of the supplier's compliance information.

42. A method for assessing supplier compliance with a customer's contract terms, conditions, and applicable regulations, comprising the steps of:
obtaining supplier information from a customer in order to collect supplier compliance information that includes the customer's contract terms, conditions, and applicable regulations for a supplier;
gathering supplier compliance information from suppliers who provide the supplier compliance information in order for the supplier to engage in further business with the customer;
charging the suppliers a periodic fee for verification of the supplier's compliance information;
verifying supplier compliance information using a verification provider to provide verified supplier compliance information;
facilitating customer access to the verified supplier compliance information at no charge to the customer via a computer network; and
displaying exceptions regarding the supplier's compliance information to a customer.

43. A method as in claim 42, wherein the step of displaying exceptions further comprises the step of displaying exceptions that are not in compliance, while hiding compliance information that is not in compliance.

44. A method as in claim 42, wherein the step of displaying exceptions further comprises the step of displaying exceptions to the compliance information with a red icon and compliance information that is verified for correctness with a green icon.
